(19) United States
(12) Patent Application Publication
(10) Pub. No.: US 2007/0290381 A1
(43) Pub. Date: Dec. 20, 2007

(54) Fluid Sparger and Dissipater

(75) Inventors: Larry W. Denney, Loxahatchee, FL (US); Jianxin Du, Wellington, FL (US)

Correspondence Address: BARNES & THORNBURG LLP, 11 SOUTH MERIDIAN, INDIANAPOLIS, IN, 46204, US

(73) Assignees: Larry W Denney; Jianxin du; Biomass Processing Technology, Inc.

(21) Appl. No.: 11/596,763

(22) PCT Filed: May 16, 2005
(86) PCT No.: PCT/US05/17060

§ 371 Date: Nov. 16, 2006

Related U.S. Application Data
(60) Provisional application No. 60/571,959, filed on May 18, 2004.
(60) Provisional application No. 60/571,996, filed on May 18, 2004.
(60) Provisional application No. 60/572,166, filed on May 18, 2004.
(60) Provisional application No. 60/572,179, filed on May 18, 2004.
(60) Provisional application No. 60/572,187, filed on May 18, 2004.
(60) Provisional application No. 60/572,206, filed on May 18, 2004.
(60) Provisional application No. 60/572,226, filed on May 18, 2004.

(51) Int. Cl. B01F 3/04

(52) U.S. Cl. 261/121.1; 222/1; 261/75; 261/123; 261/124

(57) ABSTRACT

A sparger includes a conduit and a plurality of dispensing tubes extending therefrom. The dispensing tubes can be roll pins. The dispensing tubes can extend into the inner diameter of the conduit. A dissipater can be positioned to interrupt the flow of fluid exiting from the dispensing tubes.

### CROSS REFERENCE TO RELATED APPLICATIONS

This application claims the benefit under 35 U.S.C. 119(e) of U.S. Provisional Application Ser. Nos. 60/571,959; 60/571,996; 60/572,166; 60/572,179; 60/572,187; 60/572,206 and 60/572,226 filed May 18, 2004, each of which is expressly incorporated herein by reference.

### FIELD OF THE INVENTION

The present invention relates generally to the introduction of a fluid into a second fluid through a sparger. More particularly, the present invention relates to the pretreatment and fermentation of waste using a sparger to introduce a gas such as air into the fermenter and/or the use of a dissipater to dissipate the gas in the fermenter.

### BACKGROUND OF THE INVENTION

The treatment of waste and waste streams is known in the art. One method of treating a biomaterial waste stream to remove pollutants in the biomaterial waste stream is to convert the pollutants into a valuable product. The process of fermentation of the waste stream can be used to remove such pollutants from the waste stream and incorporate such pollutants (e.g., phosphorous, nitrogen, and potassium) into the valuable product. Exemplary valuable products may include, for example, an animal feed additive, a feed supplement, a fertilizer, a fertilizer ingredient, or a soil conditioner. Exemplary biomaterial waste streams that can be treated by fermentation include, but are not limited to, manure, cellulosistic solid waste, whey broth from cheese production or biomaterial waste streams from other foodstuffs, broth remediation from alcohol or yeast production, tannery waste, slaughterhouse waste, waste derived from plants, and land fill waste. The waste derived from plants can be, for example, waste from hay, leaves, weeds, or wood and can be, for example, yard waste, landscaping waste, agricultural crop waste, forest waste, pasture waste, or grassland waste. Where the biomaterial waste stream is manure, the manure can be from an animal such as a human, a bovine animal, an equine animal, an ovine animal, a porcine animal, or poultry. The biomaterial waste stream can be variable and dilute biomaterial waste stream derived from manure.

### SUMMARY OF THE INVENTION

The present invention comprises one or more of the features, or combinations thereof, outlined in the attached claims and in the following paragraphs. A sparger may comprise a conduit having a plurality of dispensing tubes exiting therefrom. The dispensing tubes may have substantially cylindrical walls and have an axially-extending slit defined therein. The dispensing tubes may be roll pins. The dispensing tubes may be coupled to the conduit such that a portion of the dispensing tube is disposed within the conduit. The dispensing tubes may each have an outer end that extends away from the conduit and an inner end that extends into the inner diameter of the conduit. Approximately half of the dispensing tube may extend into the inner diameter of the conduit.

A dissipater may be provided, the dissipater being spaced apart from the outer end of the dispensing tube so as to intercept the flow of fluid exiting from the outer end of the dispensing tube. The dissipater may be disc shaped, or may have other shapes. The dissipater may have geometric channels formed therein. The geometric channels may be triangular shaped. The channels may extend axially outwardly from the center of the dissipater.

Illustratively, the fermentation unit used to treat the biomaterial waste stream is an air-lift fermenter and the fermentation method can be continuous flow fermentation where the fermentation is oxidative fermentation and the fermentation is made oxidative by injecting sterilized air into the fermentation unit. In one embodiment, the fermentation unit is cylindrical and the highest concentration of microorganisms is in the bottom half of the cylinder. The fermentation unit may have multiple inner cylinders. In another embodiment, the fermentation unit can have an upwardly opening receptacle at the bottom of the fermentation unit for collection of the microorganism, and the lower portion of the upwardly opening receptacle can be tapered for collection of the microorganism in the tapered region of the receptacle for removal of the microorganism from the fermentation unit through a product outlet port. In other embodiments, the receptacle can have a first air inlet to inject air into the receptacle. The injection of air into the receptacle can remove at least a portion of the microorganisms that have collected in the receptacle out of the receptacle so that the concentration of microorganisms in the receptacle is reduced. As a result, the amount of the microorganism that is removed from the fermentation unit after collection in the receptacle is reduced. The fermentation unit can also have a second air inlet to inject air into the fermentation unit at a location outside of the receptacle to circulate the microorganisms in the fermentation unit.

Spargers, as used herein, are mechanical devices that direct a first fluid such as gas or air into a second fluid such as waste so as to promote mixing of the first fluid with the second fluid. Such fluids may be liquid or gas, and are ideally intermixed to a desired optimal-mix state. Dissipaters, as used herein, are devices that facilitate the dissipation of the first fluid into the second fluid. When dissipating gases into a liquid, such gases are prone to coalescing with other molecules of the gas so as to form larger bubbles than possibly desired. Dissipaters and spargers can be used to control such coalescing.

A valuable product, for example, a microorganism, reducing environmental pollution. In one embodiment, fermentation of waste by the disclosed method results in the production of a valuable protein product (e.g., a fermenting microorganism such as a yeast) that can be used, for example, as an animal feed additive, a feed supplement, a fertilizer, a fertilizer ingredient, or a soil conditioner.

### BRIEF DESCRIPTION OF THE DRAWINGS

FIG. 1 shows a representation of a prior art air sparger having a pipe and dispensing tube configuration;

FIG. 2 shows a pipe having a dispensing tube coupled thereto according to one embodiment of the present invention;

FIG. 3 shows a dispensing tube directed toward a dissipater; and

FIG. 4 shows one embodiment of a configuration for a dissipater.

### DESCRIPTION OF THE ILLUSTRATIVE EMBODIMENTS

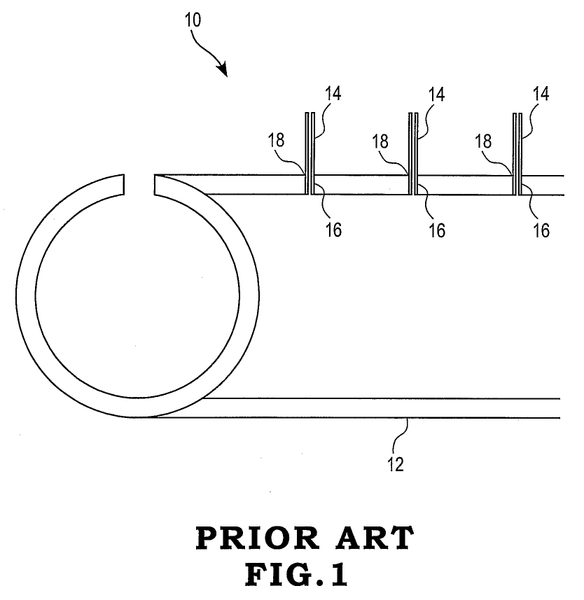

An exemplary prior art sparger 10 can be seen in FIG. 1. Such a sparger 10 comprises a conduit 12 and a plurality of dispensing tubes 14 mounted thereon. As shown in FIG. 1, dispensing tubes 14 typically can be mounted to extend from an aperture 16 that is formed in the wall of conduit 12. Additionally, a weld 18 typically secures each dispensing tube 14 inside aperture 16.

When air is dispensed from such a sparger 10, dispensing tubes 14 may be subjected to vibrations due to the gas or air bubbles exhausting from the end of the tubes 14. The higher-pressure gas accelerates as it travels through the dispensing tubes 14, and forms bubbles as it exits the tubes into the lower-pressure fluid. As the pressure of the liquid or second fluid causes each bubble to form and depart from the tube, the tube vibrates from the impact of the returning fluid. Such vibrations may cause welds 18 to fail.

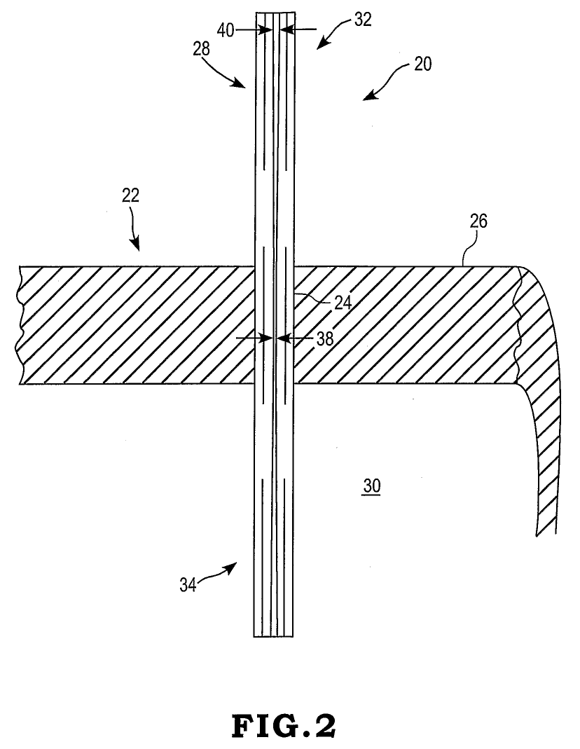

A fluid sparger 20 according to the present invention can be seen in FIG. 2. Such a sparger is illustratively used to dispense air into a waste stream, however, it should be understood that other uses and configurations are within the scope of the disclosure. As shown in FIG. 2, pipe or conduit 22 illustratively has a plurality of apertures 24 drilled or formed through its cylindrical wall 26. Illustratively, a dispensing tube 28 is positioned in each aperture 24. Dispensing tube 28 has an outer end 32 and an inner end 34. Illustratively, outer end 32 extends outwardly away from conduit 22, and inner end 34 extends inside the inner diameter region 30 of conduit 22.

Dispensing tube 28 is illustratively manufactured and utilized in the following fashion. However, it should be understood that variations may exist, and are within the scope of the disclosure. Dispensing tube 28 is illustratively a roll pin which defines a tube having a substantially cylindrical wall. A slit 36 extends axially along at least a portion of the cylindrical wall.

Roll pins, also known as spring pins, are common off-the-shelf items of manufacture that have many uses in industrial settings. Additionally, insertion tools for roll pins are common and readily available, and facilitate easy mounting and removal of the roll pins.

Dispensing tube 28 is a roll pin having an illustrative outer diameter of approximately 1/16 inch (0.159 centimeter), and an inner diameter of approximately 1/32 inch (0.079 centimeter). Illustratively, such a roll pin is formed of 18-8 stainless steel and has a length of one inch (2.54 centimeter). It should be understood, of course, that other sizes and dimensions are within the scope of the disclosure, and other dimensions may be advantageous when seeking varied results and sparger characteristics.

Aperture 24 is illustratively drilled or formed in conduit 22 as a 0.0675 inch (0.171 centimeter) diameter hole that can accommodate a roll pin as described above. Using a roll pin insertion tool, the illustrative dispensing tube 28 can be inserted into aperture 24. When the proper position for dispensing tube 28 relative to aperture 24 is attained, the insertion tool can be released, and dispensing tube 28 allowed to expand radially to engage the walls of the aperture 24.

Such an expansion of the roll pin may result in a space being formed as the slit 36 opens. However, the illustrative dimension 38 of slit 36 after insertion of dispensing tube 28 will be as little as 0.0-0.001 inch (0-0.00254 centimeter) at the point of the aperture 24. The illustrative dimension 40 of slit 36 at outer end 32 or inner end 34 of dispensing tube 28 may be slightly larger than dimension 38, due to spreading of the roll pin. However, it should be understood that such a dimension 40 is not of sufficient magnitude so as to cause substantial leaking of fluid through the slit 36, and that fluid flow through dispensing tube 28 is substantially axial.

Dispensing tubes 28 can have an optimal length that creates a desired fluid distribution when the fluid is dispensed from the tubes 28. Such a fluid distribution, for example, is a desired bubble size when a gas is exhausted from the tubes 28 into a surrounding fluid, such as a waste stream.

Dispensing tubes 28 according to the present disclosure can be inserted into the conduit 22 and still provide the benefits of having a particular length that is considered optimal to performance. By having a portion, for example half, of the length of the dispensing tube 28 disposed within the inner diameter region 30 of the conduit 22, the dispensing tube is more protected from breakage than if it were extending completely outside the conduit 22. The same effective geometry (i.e. length, internal diameter, and wall thickness) can be accomplished with only half of the protruding length. Furthermore, because dispensing tubes 28 are roll pins that actively exert outward pressure in order to press-fit into engagement with the aperture 24, the roll pins can be more reliable than the prior art welded tubes. Repairs, replacements, and cleanings are likewise easier with roll pins than with welded tubes. Yet a further advantage is the simplicity of manufacture and the savings of costs due to not having a welding process.

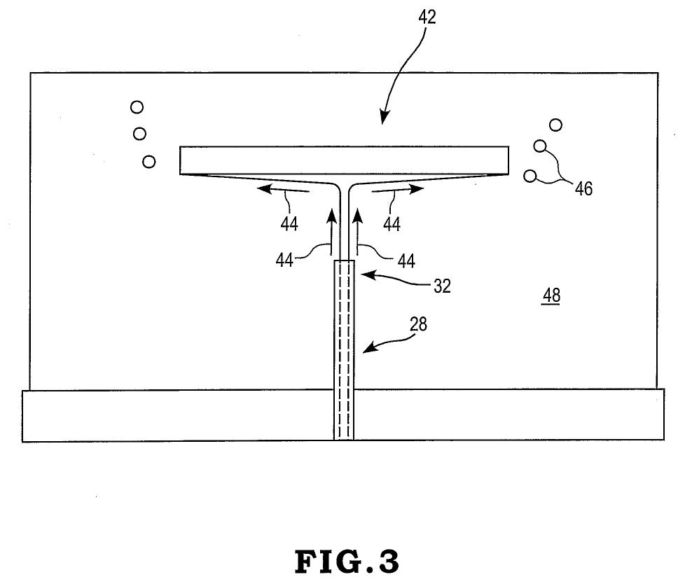

FIG. 3 illustrates a dispensing tube 28 having an outer end 32 directed toward a dissipater 42. According to the disclosure, such a dissipater 42 is spaced apart from the outer end 32, yet sufficiently close so as to dissipate the flow of fluid that exits from outer end 32, as indicated by arrows 44. As the flow of fluid disperses radially from the initial contact point with dissipater 42, the flow takes on the form of small particles of the fluid, illustratively, small bubbles 46. Such small bubbles more easily dissipate into the surrounding fluid (or second fluid) 48 shown in FIG. 3. It should be understood that fluid flow rates, dispensing tube dimensions, dissipater configurations/dimensions, and dissipater positioning can be varied or altered to provide a range of bubble sizes. Optimal bubble sizes may vary depending on the particular application of the sparger and dissipater and the particular goals of the application.

The flow of fluid over a dissipater according to the disclosure can be described as follows. Assuming the impingement area is at the center of dissipater, the area within a certain measurable radius can be defined as witnessing mostly the transition of the flow of fluid from the direction of the stream to a direction parallel with the dissipater. A second area at a greater radius represents the area where the flow is most typically radially outward. Yet a third area at an even greater radius than the second area represents the area in which the outward velocity of the fluid flow has slowed to the point that fragmentation of the gas will occur due to some relationship of dissipater surface interaction, water pressure, and the tendency of the gas to form speriods.

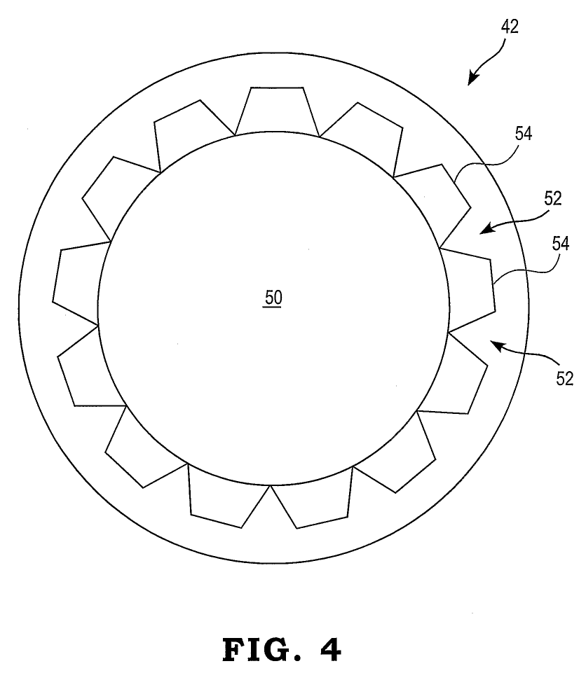

FIG. 4 shows one embodiment of a dissipater 42 having a geometric surface 50 for contacting a flow of fluid from a dispensing tube. Dissipater 42 is illustratively substantially disc-shaped, however, other shapes and geometries are within the scope of the disclosure. Surface 50 of dissipater 42 illustratively forms v-shaped channels 52 that are concentrically spaced at a pre-selected radial distance from the center of dissipater 42. Such channels 52 facilitate the distribution of air bubbles or fluid bubbles into preselected areas pursuant to the geometry of dissipater 42. In the illustrative example, 12 channels 52 are provided, thereby offering 12 discrete areas that channel bubbles.

It should be understood that other geometries are within the scope of the disclosure, and can be utilized as desired for the particular application. For example, ribs 54, between which channels 52 are formed, could be shaped in any number of manners, including a full-length triangle rather than a truncated triangle, or any other geometric shape. It is also within the scope of the disclosure to provide channels that are carved into dissipater 42, which don't have ribs 54 there between. A single dissipater 42 may be used in combination with a plurality of dispensing tubes, or each dispensing tube 28 may be associated with its own dissipater 42. Dissipater 42 may be formed substantially cylindrically, and may be positioned to intercept a plurality of fluid flows along an axial line on the dissipater.

A method is also disclosed. The method comprises the steps of dispensing a fluid into a fermentation tank through a dispenser, and directing the dispenser toward a dissipater so that the fluid is interrupted by the dissipater after being dispensed into the fermentation tank. The dispenser is a roll pin that is an elongated hollow cylinder having an axially extending slit therethrough.

The fluid sparger and dissipater described herein may be implemented, without limitation, in a fermentation structure and process forming part of a biomaterial waste processing system. One example of such a fermentation structure and process forming part of an overall biomaterial waste processing system is disclosed in each of co-pending PCT Applications Serial. Nos. PCT/US2005/______, entitled SYSTEM FOR PROCESSING A BIOMATERIAL WASTE STREAM (attorney docket no. 35479-77858), PCT/US2005/______, entitled FLOCCULATION METHOD AND FLOCCULATED ORGANISM (attorney docket no. 35479-77852), PCTUS/2005/______, entitled FERMENTER AND FERMENTATION METHOD (attorney docket no. 35479-77851), PCT/US2005/______, entitled SYSTEM FOR TREATING BIOMATERIAL WASTE STREAMS (attorney docket no. 35479-77848) and PCT/US2005/______, entitled SYSTEM FOR REMOVING SOLIDS FROM AQUEOUS SOLUTIONS (attorney docket no. 35479-77847), all of which are assigned to the assignee of the present invention, and the disclosures of which are all incorporated herein by reference.

We claim:

1. A sparger for dispersing a first fluid into a second fluid, the sparger comprising:
a conduit configured to carry the first fluid, the first fluid having a first pressure, and
a plurality of dispensing tubes coupled to the conduit and configured to dispense the first fluid into the second fluid, the second fluid having a second pressure that is lower than the first pressure, each dispensing tube having a length and an axis,
wherein each dispensing tube comprises a substantially cylindrical wall having an axially-extending slit defined therein.

2. The sparger of claim 1, wherein each dispensing tube is a roll pin.

3. The sparger of claim 1, wherein the conduit defines an outside wall and an inner diameter, and a portion of the dispensing tube extends through the outside wall and into the inner diameter of the conduit.

4. The sparger of claim 3, wherein approximately half of each dispensing tube extends into the inner diameter of the conduit.

5. The sparger of claim 1, wherein the conduit has a plurality of apertures formed therein, and each dispensing tube is radially compressed prior to insertion into one of the apertures to form a press-fit engagement with the aperture.

6. The sparger of claim 1, wherein each dispensing tube includes an outer end extending away from the conduit,
and further comprising a dissipater spaced apart from the outer end of the dispensing tube.

7. The sparger of claim 6, wherein the dispensing tube directs a flow of the first fluid into the second fluid, and the dissipater interrupts the flow of the first fluid after the flow exits the dispensing tube.

8. The sparger of claim 6, wherein the dissipater comprises a flat surface.

9. The sparger of claim 6, wherein the dissipater comprises a smooth surface.

10. The sparger of claim 6, wherein the dissipater comprises a curved surface.

11. A sparger for dispensing a fluid into a fermentation tank, the sparger comprising:
a conduit configured to carry the fluid into the fermentation tank, and
a dispensing tube coupled to the conduit and configured to dispense the fluid from the conduit into the fermentation tank,
wherein the dispensing tube is a roll pin.

12. The sparger of claim 11, wherein the conduit has a substantially cylindrically shaped cross-section defining an outside wall and an inner diameter, and a portion of the dispensing tube extends through the outside wall and into the inner diameter of the conduit.

13. The sparger of claim 12, wherein approximately half of the dispensing tube extends into the inner diameter of the conduit.

14. The sparger of claim 11, wherein the conduit has an aperture formed therein, and the dispensing tube is radially compressed prior to insertion into the aperture in order to form a press-fit engagement with the aperture.

15. The sparger of claim 11, further comprising a dissipater.

16. The sparger of claim 15, wherein the dissipater is positioned to interrupt the fluid after it is dispensed into the fermentation tank.

17. The sparger of claim 15, wherein the dissipater comprises a plate.

18. The sparger of claim 15, wherein the dissipater has a curved surface for contact with the fluid.

19. A method of dispensing a fluid into a fermentation tank, the method comprising the steps of:
dispensing the fluid into the fermentation tank through a dispenser; and
directing the dispenser toward a dissipater so that the fluid is interrupted by the dissipater after being dispensed into the fermentation tank.

20-26. (canceled)

27. A sparger for dispensing a fluid into a fermentation tank, the sparger comprising:
a conduit configured to carry the fluid into the fermentation tank, the conduit defining an inner region and an outer wall, and
a dispensing tube coupled to the outer wall of the conduit and configured to dispense the fluid from the conduit into the fermentation tank, the dispensing tube extending into the inner region of the conduit.

28. The sparger of claim 27, wherein the dispensing tube is a roll pin.
